(19) United States
(12) Patent Application Publication
(10) Pub. No.: US 2014/0202329 A1
(43) Pub. Date: Jul. 24, 2014

(54) Enhanced Fly Ash Collection

(71) Applicant: Novinda Corporation, Denver, CO (US)

(72) Inventor: James Robert Butz, Lakewood, CO (US)

(73) Assignee: Novinda Corporation, Denver, CO (US)

(21) Appl. No.: 13/945,304

(22) Filed: Jul. 18, 2013

Related U.S. Application Data
(60) Provisional application No. 61/674,283, filed on Jul. 20, 2012.

(51) Int. Cl. B03C 3/013; H01B 1/06

(52) U.S. Cl. CPC B03C 3/013; H01B 1/06
USPC 95/60; 95/61; 252/500; 252/518.1

(57) ABSTRACT

A process of enhancing fly ash collection without adding SO₃ to a flue gas can include providing a flue gas that includes fly ash and combustion gases from a coal fired boiler; injecting into the flue gas a particulate resistivity aid; and then collecting the fly ash and particulate resistivity aid with a cold side electrostatic precipitator (ESP).

### CROSS-REFERENCE TO RELATED APPLICATIONS

This disclosure claims the benefit of priority to U.S. Provisional Patent Application No. 61/674,283 filed 20 Jul. 2012, the disclosure of which is incorporated herein in its entirety.

### FIELD OF THE INVENTION

This disclosure is related to agents for and improvements in the capture of fly ash (e.g., produced from the combustion of coal) with an electrostatic precipitator.

### BACKGROUND

Electrostatic precipitators (ESPs) have been used in many industries; for example cement, refinery and petrochemical, pulp and paper and power generation. Although the physical operation of a precipitator is simple and essentially the same for each industry, involving particle charging, collection, dislodging and disposal, the sizing of a precipitator is more complex.

The typical equation used in precipitator sizing is the modified Deutsch equation: Efficiency=1−e^{-(A/V·w)}^{^{y}}. Where A is the collecting electrode surface area, V is the gas volume and w is the precipitation rate. The exponent y is a variable based on test data for each specific application. Additional factors that influence precipitator sizing include: gas volume, precipitator inlet loading, precipitator outlet loading, outlet opacity, particulate resistivity, and particle size.

Particulate resistivity is used to describe the resistance of a medium to the flow of an electrical current. By definition, resistivity, which has units of ohm-cm, is the electrical resistance of a dust sample having a volume of 1 cm³. Resistivity levels are generally broken down into three categories: low; under 1×10⁸ ohm-cm, medium; 1×10⁸ to 2×10¹¹ ohm-cm, and high; above 2×10¹¹ ohm-cm.

Particles in the medium resistivity range are the most acceptable for electrostatic precipitators. Particles in the low range are easily charged; however upon contact with the collecting electrodes, they rapidly lose their negative charge and are re-entrained into the gas stream to either escape or to be recharged by the corona field. Particles in the high resistivity category may cause back corona which is a localized discharge at the collecting electrode due to the surface being coated by a layer of non-conductive material.

Resistivity is influenced by flue gas temperature and conditioning agents, such as flue gas moisture and ash chemistry. Conductive chemical species will tend to reduce resistivity levels while insulating species, such as SiO₂, Al₂O₃ and Ca will tend to increase resistivity. In those cases where high resistivity is encountered, such as the utility industry when low sulfur coal is being fired, flue gas conditioning with SO₃ can reduce resistivity to a more optimum value thus reducing the size of the precipitator that is needed.

Electrostatic precipitators are also grouped according to the temperature of the flue gas that enters the ESP: cold-side ESPs are used for flue gas having temperatures of approximately 204° C. (400° F.) or less; hot-side ESPs are used for flue gas having temperatures greater than 300° C. (572° F.).

In describing ESPs installed on industrial and utility boilers, or municipal waste combustors using heat recovery equipment, cold side and hot side also refer to the placement of the ESP in relation to the combustion air preheater. A cold-side ESP is located behind the air preheater, whereas a hot-side ESP is located in front of the air preheater. The air preheater is a tube section that preheats the combustion air used for burning fuel in a boiler. When hot flue gas from an industrial process passes through an air preheater, a heat exchange process occurs whereby heat from the flue gas is transferred to the combustion air stream. The flue gas is therefore “cooled” as it passes through the combustion air preheater. The warmed combustion air is sent to burners, where it is used to burn gas, oil, coal, or other fuel including garbage.

### SUMMARY

A first embodiment is a process of enhancing fly ash collection without adding SO₃ to a flue gas. The process involves providing a flue gas that includes fly ash and combustion gases from a coal fired boiler; injecting into the flue gas a particulate resistivity aid; and then collecting the fly ash and particulate resistivity aid with a cold side electrostatic precipitator (ESP).

Another embodiment is a process of enhancing fly ash collection that involves providing a flue gas that includes fly ash with a resistivity in a range of about 10¹¹ to about 10¹⁴ ohm-cm (e.g., above 2×10¹¹ ohm-cm) at a temperature of about 150° C. to about 250° C. and combustion gases from a coal fired boiler; injecting into the flue gas a particulate resistivity aid; and then collecting the fly ash and particulate resistivity aid with a cold side electrostatic precipitator (ESP).

Yet another embodiment is a process of enhancing fly ash collection that involves providing a flue gas that includes fly ash and combustion gases from a coal fired boiler that is burning Powder River Basin coal; injecting into the flue gas a particulate resistivity aid thereby reducing a resistivity of the fly ash by one order of magnitude (ohm-cm); and then collecting the fly ash and particulate resistivity aid with a cold side ESP.

Still another embodiment is a particulate resistivity aid that includes a particulate support selected from the group consisting of a silicate, an aluminate, a metal oxide, a polymeric support, and mixtures thereof; and a resistivity agent carried by the particulate support.

### BRIEF DESCRIPTION OF THE DRAWINGS

For a more complete understanding of the disclosure, reference should be made to the following detailed description and accompanying drawing FIGURES wherein:

FIG. 1 is a graph of the resistivity of fly ash and fly ash in the presence of the herein described particulate resistivity aid (“R.A.”).

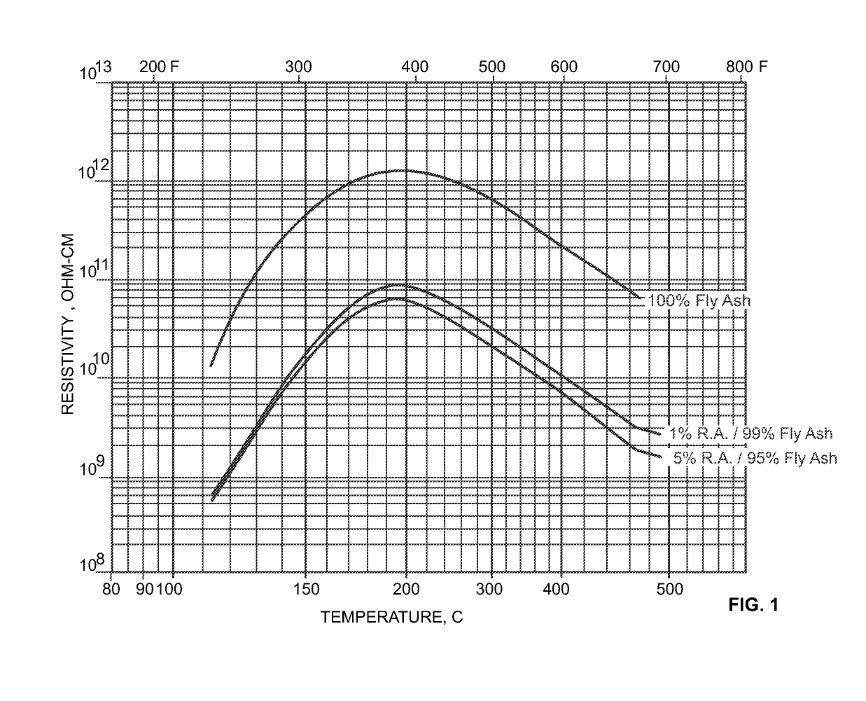

While specific embodiments are illustrated in the FIGURES, with the understanding that the disclosure is intended to be illustrative, these embodiments are not intended to limit the invention described and illustrated herein.

### DETAILED DESCRIPTION

Described herein is a process of enhancing the collection of fly ash without the addition of SO₃ to the flue gas. Preferably, the process is essentially free of or completely free of the addition of SO₃ to the flue gas; less preferably, the process includes a reduction but not the elimination of the addition of SO₃ to the flue gas. The described process includes the reduction of the resistivity of the fly ash and thereby the enhanced collection of the fly ash in an electrostatic precipitator (ESP). Importantly, the process includes the collection of the agent (i.e., the particulate resistivity aid) that affects the resistivity of the fly ash.

As used herein, fly ash has its commonly understood meaning; that is, fly ash is the (silicate, aluminate, and other) non-combustible solid particulates that result from the combustion of fossil fuels, including coal, petroleum, and lignites. The fly ash produced from the combustion process has a resistivity measured in ohm-cm. Herein, the “native fly ash resistivity” is the resistivity of the fly ash after exiting a boiler and before the resistivity is augmented by adding chemicals to the fly ash. That is, the native fly ash resistivity is the resistivity of the produced fly ash as it reaches an ESP taking into account, for example, inline processing units (e.g. selective catalytic reduction (SCR) units) which might affect the resistivity of the fly ash between the boiler and the ESP. As used herein, the “admixture resistivity” is the resistivity of an admixture of the fly ash and the herein described particulate resistivity aid. Notably, native fly ash resistivity and admixture resistivity change as a function of temperature, any comparison between resistivities, be it fly ash resistivities and/or admixture resistivities, are at the same temperature or within a sufficiently small temperature range to negate the effect of temperature on the resistivity.

In a first embodiment, the process of enhancing fly ash collection includes providing a flue gas that includes fly ash and combustion gases from a coal fired boiler; injecting or adding into the flue gas a particulate resistivity aid (e.g., forming an admixture that includes the fly ash and the particulate resistivity aid); and then collecting the fly ash and particulate resistivity aid (the admixture) with a cold side ESP. Preferably, the process enhances the collection of fly ash from the flue gas without adding SO₃ to a flue gas.

In another embodiment, the process of enhancing fly ash collection includes providing a flue gas at a temperature of about 120° C. or about 150° C. to about 250° C. or about 300° C., the flue gas including fly ash with a resistivity (native fly ash resistivity) in a range of about 10¹¹ to about 10¹⁴ ohm-cm, preferably a resistivity above 2×10¹¹, and combustion gases from a coal fired boiler; injecting into the flue gas a particulate resistivity aid; and then collecting the fly ash and particulate resistivity aid with a cold side ESP. Preferably, the fly ash resistivity is reduced to about 10⁸ to about 10¹¹ ohm-cm or about 2×10¹¹ ohm-cm (admixture resistivity), more preferably the admixture resistivity is below 2×10¹¹ ohm-cm.

In still another embodiment, the process of enhancing fly ash collection can include providing a flue gas that includes fly ash and combustion gases from a coal fired boiler that is burning Powder River Basin coal; injecting into the flue gas a particulate resistivity aid thereby reducing a resistivity of the fly ash by at least about one order of magnitude (ohm-cm); and then collecting the fly ash and particulate resistivity aid with a cold side ESP.

In these embodiments, the process, preferably, reduces particulate emissions (e.g., fly ash emissions) from the ESP by at least about 10%, about 20%, about 30%, about 40%, or about 50%. In multi-field ESPs, the reduction in particulate emissions can be measured after each field. In one preferable example, a first-field ESP collected mass fraction is increased by at least 5%. That is, the percentage of particulates collected by the first-field in the ESP is increased by at least 5% (e.g., from about 90% to about 95%).

In these embodiments, the particulate resistivity aid, preferably, includes a particulate support and a resistivity aid. Preferably, the particulate support carries the resistivity agent, where carrying includes any physio-chemical relationship between the particulate support and the resistivity agent. That is, carrying can include the adhesion of the resistivity agent to a surface of the particulate support, the ionic or electrostatic bonding of the resistivity agent to a surface of the particulate support, the intercalation of the resistivity agent into the particulate support, or into or between layers of the particulate support. Preferably, carrying excludes mixtures of the particulate support and resistivity agent that completely dissociate upon mixing with a gas or dispersion into a gas. Even more preferably, the particulate resistivity aid consists essentially of the particulate support carrying the resistivity agent.

The particulate support can be selected from silicates, aluminates, metal oxides (e.g., transition metal oxides such as titanates, vanadates, tungstates, molybdates, and ferrates; and alkali and/or alkali earth oxides such as calcium oxides), polymeric supports, and mixtures thereof. Examples of particulate supports include but are not limited to phyllosilicates (e.g., vermiculite, montmorillonite, bentonite, and kaolinite) allophane, graphite, quartz, and mixtures thereof.

Preferably, the particulate support does not affect the resistivity of the fly ash, that is, does not affect the native fly ash resistivity. More preferably, the particulate support does not reduce the native fly ash resistivity. Even more preferably, the particulate support does not reduce the native fly ash resistivity by a factor greater than about five when added to the fly ash in an amount less than about 50 wt. %, 25 wt. %, 10 wt. %, 5 wt. %, or 2.5 wt. %. Still more preferably, the particulate support, when free of the resistivity agent, has a particulate support resistivity that is equal to or greater than the native fly ash resistivity.

The particulate resistivity aid includes a resistivity agent carried by the particulate support. The resistivity agent, preferably, affects the resistivity of the fly ash. In an example, an unsupported resistivity agent may be capable of affecting the resistivity of the fly ash but the supported resistivity agent has been found to have an enhanced effect on the resistivity of the fly ash. That is, the activity (as measured in the reduction of the native fly ash resistivity) of the supported resistivity agent is greater than the unsupported resistivity agent on a gram/gram basis of resistivity agent. For example, one kilogram of supported resistivity agent (carried by sufficient quantity of the particulate support) has a greater activity than one kilogram of unsupported resistivity agent. The supported resistivity agent activity is enhanced (when compared to the unsupported resistivity agent activity) despite the resistivity of the particulate support (when free of the resistivity agent). Compositionally, the resistivity agent can include iron, copper, tin, titanium, calcium, sodium, and mixtures thereof. In one preferable example, the resistivity agent includes the sulfide of iron, copper, tin, titanium, calcium, sodium, or mixtures thereof. The sulfide can be a terminal sulfide, a polysulfide, or a thiolate. One particularly preferable combination for the resistivity agent includes copper and sulfur (e.g., a copper sulfide). Another particularly preferable combination for the resistivity agent includes sodium and sulfur (e.g., a sodium sulfide).

One particularly preferable particulate resistivity aid consists of the particulate support carrying a resistivity agent. Here, the particulate support is a phyllosilicate, preferable a bentonite. The resistivity agent can be one or more compounds carried by the phyllosilicate but includes a water-soluble, alkali metal salt. The water-soluble, alkali metal salt can be selected from a sodium salt, a potassium salt, and a mixture thereof; preferably, the water-soluble, alkali metal salt is a sodium salt (e.g., sodium chloride, trona, sodium carbonate, sodium bicarbonate, sodium hydroxide, or mixtures thereof). Notably, the resistivity agent can include, in addition to the water-soluble, alkali metal salt, a transition metal (e.g., a first row transition metal) or a transition metal compound.

Notably, the particulate resistivity aid has a ratio of the particulate support to the resistivity agent. The ratio is, preferably, in a range of about 1:1 (about 50 wt % resistivity agent) to about 99:1 (about 1 wt % resistivity agent) by weight, or in a range of about 4:1 (about 20 wt % resistivity agent) to about 19:1 (about 5 wt % resistivity agent) by weight. For example the particulate resistivity aid can include about 0.5 wt. %, about 1 wt. %, about 2 wt. %, about 3 wt. %, about 4 wt. %, about 5 wt. %, about 10 wt. %, about 15 wt. %, about°wt. %, about 25 wt. %, about 30 wt. %, about 35 wt. %, about 40 wt. %, about 45 wt. %, or about 50 wt. % or the resistivity agent.

The manufacture of the particulate resistivity aid can be by any method that provides the resistivity agent carried by the particulate support. One example is an incipient wetness process wherein the resistivity agent and particulate support are sheared with sufficient liquid (preferably water) to facilitate an interaction or reaction between the resistivity agent and particulate support, and then the removal of all or most of the liquid. The particulate resistivity aid is, preferably, not manufactured by the dry blending of the particulate support and the resistivity agent as dry blending procedures typically produce a mixture of the materials not the herein disclosed particulate resistivity aid. In limited circumstances, dry blending is possible when the blended materials are sufficiently solvated (e.g., hydrated) to generate free solvent (water) during the blending process.

The process of enhancing fly ash collection further includes the injection of the particulate resistivity aid into the flue gas. The location for the injection of the particulate resistivity aid can be between an air preheater and the ESP or upstream/before the air preheater. When the particulate resistivity aid is injected before the air heater, the particulate resistivity aid flows through the air preheater before being collected by the ESP.

In a preferable example, the particulate resistivity aid is injected into the fly ash to produce produces an admixture of the fly ash and particulate resistivity aid that includes about 0.1 wt. % to about 5 wt. % or about 0.1 wt % to about 1 wt % of the particulate resistivity aid; for example, an admixture that includes about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.25 wt. %, about 1.5 wt. %, about 1.75 wt. %, about 2 wt. %, about 2.5 wt. %, about 3 wt. %, about 3.5 wt. %, about 4 wt. %, about 4.5 wt. %, or about 5 wt. % of the particulate resistivity aid. As the fly ash travels through the flue ducts at an average weight per hour, the particulate resistivity aid can be injected into the flue duct and thereby the flue gas and mixed with the fly ash at an average weight per hour to yield the fly ash-particulate resistivity aid mixture that includes about 1 wt. % to about 5 wt. % of the particulate resistivity aid. For example, if 80 kg of fly ash is produce per hour by a coal fired boiler, the particulate resistivity aid can be injected into the flue duct carrying the fly ash at a rate of about 0.8 kg (about 1 wt. %) to about 4 kg (about 5 wt. %) per hour.

What is claimed:

1. A process of enhancing fly ash collection comprising:
providing a flue gas that includes fly ash, which has a native fly ash resistivity, and combustion gases from a coal fired boiler;
adding into the flue gas a particulate resistivity aid that consists essentially of a particulate support carrying a resistivity agent;
reducing the native fly ash resistivity to an admixture resistivity; and then
collecting an admixture of the fly ash and particulate resistivity aid with a cold side electrostatic precipitator (ESP);
wherein a collected mass fraction of fly ash is increased without the addition of SO₃.

2. The process of claim 1, wherein a first-field ESP, collected mass fraction is increased by at least 5%.

3. The process of claim 1, wherein fly ash emissions from the ESP are reduced by at least 10%.

4. The process of claim 1, wherein the particulate resistivity aid is injected into the flue gas between an air preheater and the ESP.

5. The process of claim 1, wherein the particulate resistivity aid is injected before an air preheater; and wherein the particulate resistivity aid flows through the air preheater before being collected by the ESP.

6. The process of claim 1, wherein injecting the particulate resistivity aid into the fly ash produces an admixture of the fly ash and particulate resistivity aid that includes about 0.1 wt. % to about 5 wt. % of the particulate resistivity aid.

7. The process of claim 1, wherein the particulate support does not reduce the native fly ash resistivity.

8. The process of claim 1, wherein the particulate support has a support resistivity that is greater than the native fly ash resistivity.

9. The process of claim 1, wherein the resistivity agent includes a water-soluble, alkali metal salt.

10. The process of claim 9, wherein the water-soluble, alkali metal salt is selected from a sodium salt, a potassium salt, and a mixture thereof.

11. The process of claim 10, wherein the water-soluble, alkali metal salt is a sodium salt.

12. The process of claim 9, wherein the resistivity agent further includes a transition metal.

13. The process of claim 1, wherein the particulate resistivity aid has a ratio of the particulate support to the resistivity agent in a range of about 1:1 (50 wt. %) to about 99:1 (1 wt %) by weight.

14. The process of claim 13, wherein the ratio of the particulate support to the resistivity agent in a range of about 4:1 (20 wt %) to about 19:1 (5 wt %) by weight.

15. A process of enhancing fly ash collection comprising:
providing a flue gas that includes fly ash with a resistivity in a range of about 10¹¹ to about 10¹⁴ ohm-cm at a temperature of about 150° C. to about 250° C. and combustion gases from a coal fired boiler;
injecting into the flue gas a particulate resistivity aid; and then
collecting the fly ash and particulate resistivity aid with a cold side electrostatic precipitator (ESP).

16. The process of claim 15, wherein injecting the particulate resistivity aid reduces the admixture resistivity to about 10⁸ to about 2×10¹¹ ohm-cm.

17. A process of enhancing fly ash collection comprising:
providing a flue gas that includes fly ash and combustion gases from a coal fired boiler that is burning Powder River Basin coal;
injecting into the flue gas a particulate resistivity aid thereby reducing a resistivity of the fly ash by at least about one order of magnitude (ohm-cm); and then
collecting the fly ash and particulate resistivity aid with a cold side electrostatic precipitator (ESP).

18. A particulate resistivity aid comprising:
a particulate support selected from the group consisting of a silicate, an aluminate, a metal oxide, a polymeric support, and mixtures thereof; and
a resistivity agent carried by the particulate support.

19. The particulate resistivity aid of claim 18, wherein the resistivity agent includes a water-soluble, alkali metal salt.

20. The particulate resistivity aid of claim 18, wherein the particulate resistivity aid consists essentially of the particulate support and the resistivity agent,
wherein the resistivity agent includes a water-soluble, alkali metal salt.

21. The particulate resistivity aid of claim 18, wherein the particulate resistivity aid has a ratio of the particulate support to the resistivity agent in a range of about 1:1 to about 99:1 by weight.

22. The particulate resistivity aid of claim 21, wherein the ratio of the particulate support to the resistivity agent in a range of about 4:1 to about 19:1 by weight.
